(19) United States
(12) Patent Application Publication
(10) Pub. No.: US 2012/0086418 A1
(43) Pub. Date: Apr. 12, 2012

(54) Multi-phase switching regulator and driver circuit and control method thereof

(75) Inventors: Chia-Jung Lee, (US); Yuan-Huang Cheng, (US); Ting-Hung Wang, (US)

(73) Assignee: Richtek Technology Corporation, R.O.C.

(21) Appl. No.: 12/931,189

(22) Filed: Jan. 27, 2011

(30) Foreign Application Priority Data
Oct. 11, 2010 (TW) 099134630

(51) Int. Cl. G05F 1/00

(52) U.S. Cl. 323/272

(57) ABSTRACT

The present invention discloses a multi-phase switching regulator, and a driver circuit and a control method thereof. The multi-phase switching regulator includes: at least two power stages each having at least one switching power transistor which switches to convert a common input voltage to a common output voltage according to PWM signals generated by corresponding PWM controllers, respectively; a feedback circuit, generating a feedback signal according to the output voltage; a current balance circuit, generating a current balance signal according to the currents of the power stages and a phase off signal to distribute current loading among the active power stages; and a soft shutdown control circuit, generating a soft shutdown control signal according to the phase off signal to gradually change the duty of a PWM signal corresponding to a power stage, so as to softly shut down the power stage to avoid a voltage undershoot.

### BACKGROUND OF THE INVENTION

1. Field of Invention

The present invention relates to a multi-phase switching regulator, and a driver circuit and a control method for controlling a multi-phase switching regulator, wherein a power stage to be turned OFF in phase shedding mode is shut down softly.

2. Description of Related Art

FIG. 1 shows a schematic diagram of a prior art multi-phase switching regulator. As shown in the figure, a first phase PWM (Pulse-Width Modulation) controller 11 and a second phase PWM controller 21 output PWM signals PWM1 and PWM2 respectively, for controlling at least one power transistor in a first phase power stage 12 and at least one power transistor in a second phase power stage 22, to convert an input voltage Vin to an output voltage Vout. A feedback circuit 13 generates a feedback signal related to the output voltage, and inputs the feedback signal to the first phase PWM controller 11 and the second phase PWM controller 21. A current balance circuit 14 receives a first signal related to a first output current I1 and a second signal related to a second output current I2, and generates a current balance signal which is inputted to both the first phase PWM controller 11 and the second phase PWM controller 21, such that the first phase PWM controller 11 and the second phase PWM controller 21 control the first phase power stage 12 and the second phase power stage 22 in a way that the currents I1 and I2 are balanced while providing the target output current Iout. The power stages 12 and 22 may be a synchronous or asynchronous buck, boost, inverting or buck-boost converter as shown in FIGS. 2A-2J.

When a load circuit (not shown) is in light load condition, since it only requires low output current, one (or more, if there are more than two power stages) of the power stages can be turned OFF to reduce power consumption, which is the so-called phase shedding mode. In this case, a phase OFF signal is inputted to the multi-phase switching regulator to turn OFF one of the power stages, such as the second phase power stage 22 as shown in the figure. The phase OFF signal is inputted to the second phase PWM controller 21, immediately shutting down the duty ratio of the second phase PWM signal PMW2 to zero, to turn OFF the second phase power stage 22. However, during transition period, the first output current I1 provided by the first phase power stage 12 is still low and it takes certain time for the current I1 to reach to the target. Therefore, an undershoot of the output voltage often occurs, which causes the system to be unstable.

US pre-grant publication 2008/0272752 discloses a multi-phase switching regulator which can turn OFF an operating power stage while maintaining its output voltage, but this patent is only applicable to a multi-phase switching regulator having at least three power stages. Besides, this patent adds the PWM signal of the to-be-OFF phase to the first phase PWM signal, but the rising speed of the output currents of the operating phases are limited by the rising slope of corresponding inductor currents, that is, because of such limit, an output voltage undershoot may still occur.

In view of the foregoing, the present invention proposes a multi-phase switching regulator, and a driver circuit and a control method for controlling a multi-phase switching regulator, wherein a power stage to be turned OFF in phase shedding mode is shut down softly.

### SUMMARY OF THE INVENTION

The first objective of the present invention is to provide a multi-phase switching regulator.

The second objective of the present invention is to provide a driver circuit for controlling a multi-phase switching regulator.

The third objective of the present invention is to provide a control method for controlling a multi-phase switching regulator.

To achieve the objective mentioned above, from one perspective, the present invention provides a multi-phase switching regulator, comprising: a first phase power stage having at least one first switching power transistor which switches according to a first phase pulse width modulation PWM signal to control a first phase output current generated by the first phase power stage; at least one second phase power stage each having at least one second switching power transistor which switches according to a corresponding second phase pulse width modulation PWM signal to control a corresponding second phase output current generated by the second phase power stage, the first phase power stage and the at least one second phase power stage converting a common input voltage to a common output voltage; a feedback circuit generating a feedback signal according to the output voltage; a current balance circuit generating a current balance signal according to a first signal relating to the first phase output current, at least one second signal relating to the corresponding second phase output current, and a phase off signal, to distribute current loading among active power stages, wherein the phase off signal determines to turn off one or more of the at least one second phase power stage; a first phase PWM controller generating the first phase PWM signal according to the feedback signal and adjusting the first phase PWM signal according to the current balance signal; at least one second phase PWM controller each generating the corresponding second phase PWM signal according to the feedback signal and adjusting the corresponding second phase PWM signal according to the current balance signal; and a soft shutdown control circuit generating a soft shutdown control signal according to the phase off signal to gradually decrease the second phase output current of the one or more second phase power stages to be turned off to zero.

From another perspective, the present invention provides a driver circuit for controlling a multi-phase switching regulator, the multi-phase switching regulator including a first phase power stage having at least one switching power transistor which switches according to a first phase PWM signal to generate a first phase output current and at least one second phase power stage having at least one switching power transistor which switches according to at least one corresponding second phase PWM signal to generate at least one second phase output current, the first phase power stage and the at least one second phase power stage converting a common input voltage to a common output voltage, and the multi-phase switching regulator generating a feedback signal, the driver circuit comprising: a current balance circuit generating a current balance signal according to the first phase output current, the at least one second phase output current, and a phase off signal, to distribute current loading among active power stages, wherein the phase off signal determines to turn off one or more of the at least one second phase power stage; a first phase PWM controller generating the first phase PWM signal according to the feedback signal and adjusting the first phase PWM signal according to the current balance signal; at least one second phase PWM controller each generating the corresponding second phase PWM signal according to the feedback signal and adjusting the corresponding second phase PWM signal according to the current balance signal; and a soft shutdown control circuit generating a soft shutdown control signal according to the phase off signal to gradually decrease the second phase output current of the one or more second phase power stages to be turned off to zero.

In the aforementioned multi-phase switching regulator or the driver circuit for controlling a multi-phase switching regulator, preferably, each second phase PWM controller includes: a ramp generator generating a ramp signal; and a comparator generating the second phase PWM signal according to the ramp signal, the current balance signal, the soft shutdown control signal and the feedback signal, wherein the soft shutdown control signal is an increasing or decreasing signal which increases or decreases along with time, to gradually decrease a duty of the second phase PWM signal of the one or more second phase power stages to be turned off to zero.

In one embodiment, each second phase PWM controller includes a current limit circuit which compares the corresponding second signal with a current limit reference signal to control a duty of the second power transistor in the corresponding second phase power stage, such that the corresponding second phase output current does not exceed a predetermined current limit, wherein the current limit circuit receives the soft shutdown control signal as its current limit reference signal, and the soft shutdown control signal is a decreasing signal which gradually decreases the limit of the corresponding second phase output current to zero such that the corresponding second phase output current decreases to zero.

From yet another perspective, the present invention provides a control method for controlling a multi-phase switching regulator, the multi-phase switching regulator including a first phase power stage having at least one switching power transistor which switches according to a first phase PWM signal to generate a first phase output current and at least one second phase power stage having at least one switching power transistor which switches according to at least one corresponding second phase PWM signal to generate at least one second phase output current, the first phase power stage and the at least one second phase power stage converting a common input voltage to a common output voltage, and the multi-phase switching regulator generating a feedback signal, the control method comprising: generating a current balance signal according to the first phase output current, the at least one second phase output current, and a phase off signal, to distribute current loading among active power stages, wherein the phase off signal determines to turn off one or more of the at least one second phase power stage; generating the first phase PWM signal according to the feedback signal and adjusting the first phase PWM signal according to the current balance signal; generating the at least one second phase PWM signal according to the feedback signal and adjusting the at least one second phase PWM signal according to the current balance signal; and generating a soft shutdown control signal according to the phase off signal to gradually decrease the second phase output current of the one or more second phase power stages to be turned off to zero.

In the aforementioned method, the soft shutdown control signal is preferably an increasing or decreasing signal which increases or decreases along with time, to gradually decrease a duty of the second phase PWM signal of the one or more second phase power stages to be turned off to zero.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art multi-phase switching regulator.

FIGS. 2A-2J show synchronous and asynchronous buck, boost, inverting and buck-boost converters.

FIG. 3 shows an embodiment of the basic structure of the present invention.

FIGS. 4A-4B show the waveforms of the output currents and output voltage of a prior art two phase switching regulator.

FIGS. 4C-4D show the waveforms of the output currents and output voltage of a two phase switching regulator according to the present invention.

FIG. 4E shows the waveform of the phase off signal.

FIG. 5 shows an embodiment illustrating how a soft shutdown signal gradually decreases the duty of the second phase PWM signal PWM2.

FIG. 6 shows several examples of the soft shutdown signal generated by the soft shutdown control circuit 15 in FIG. 5.

FIG. 7 shows another way for the soft shutdown signal to gradually decrease the duty of the second phase PWM signal PWM2.

FIG. 8 shows several examples of the soft shutdown signal generated by the soft shutdown control circuit 15 in FIG. 7.

FIG. 9 shows an embodiment of another basic structure of the present invention.

### DESCRIPTION OF THE PREFERRED EMBODIMENTS

The spirit of the present invention is to gradually turn off a power stage phase when the multi-phase switching regulator is in light load condition, i.e., when it is not required for all the phases to operate. The present invention gradually decreases the duty of the PWM signal of the to-be-turned-off power stage phase according to the phase off signal, to gradually turn off a phase without causing an undershoot of the output voltage such that the system can keep a smooth operation.

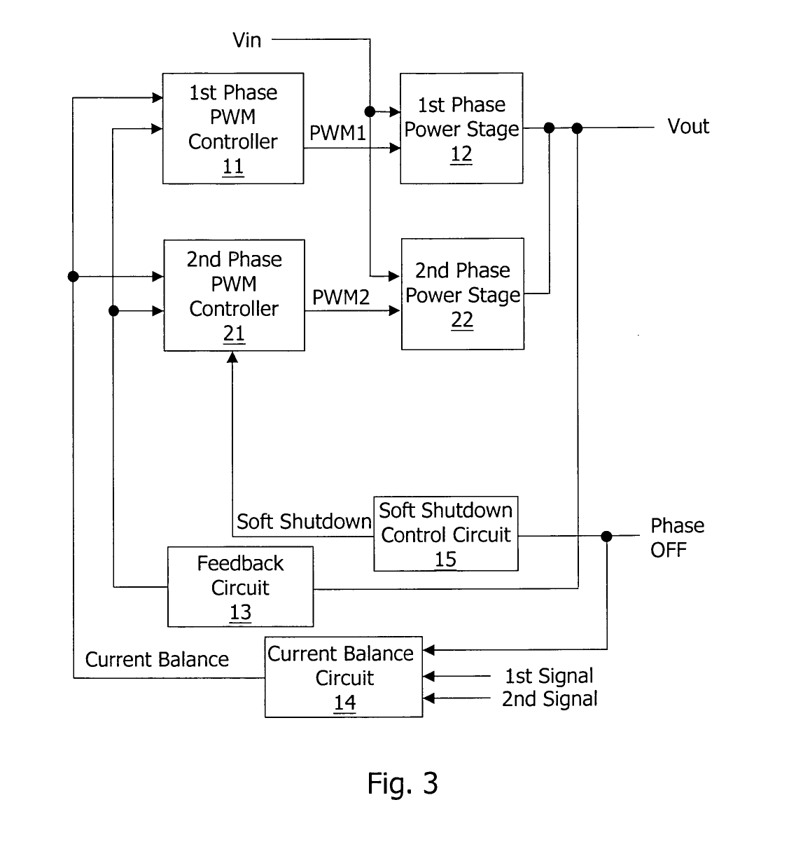

FIG. 3 shows an embodiment of the basic structure of the present invention. As shown in the figure, the present invention is different from the prior art by a soft shutdown control circuit 15 which is coupled to the second phase PWM controller 21. The soft shutdown control circuit 15 receives a phase off signal and generates a soft shutdown signal. The second phase PWM controller 21 generates a second phase PWM signal PWM2 according to a feedback signal, and directly or indirectly decreases the duty of the second phase PWM signal PWM2 according to the soft shutdown signal, so as to gradually decrease the second phase output current I2 of the second phase power stage 22 to zero. The details as to how the soft shutdown signal gradually decreases the duty of the second phase PWM signal PWM2 will be described later.

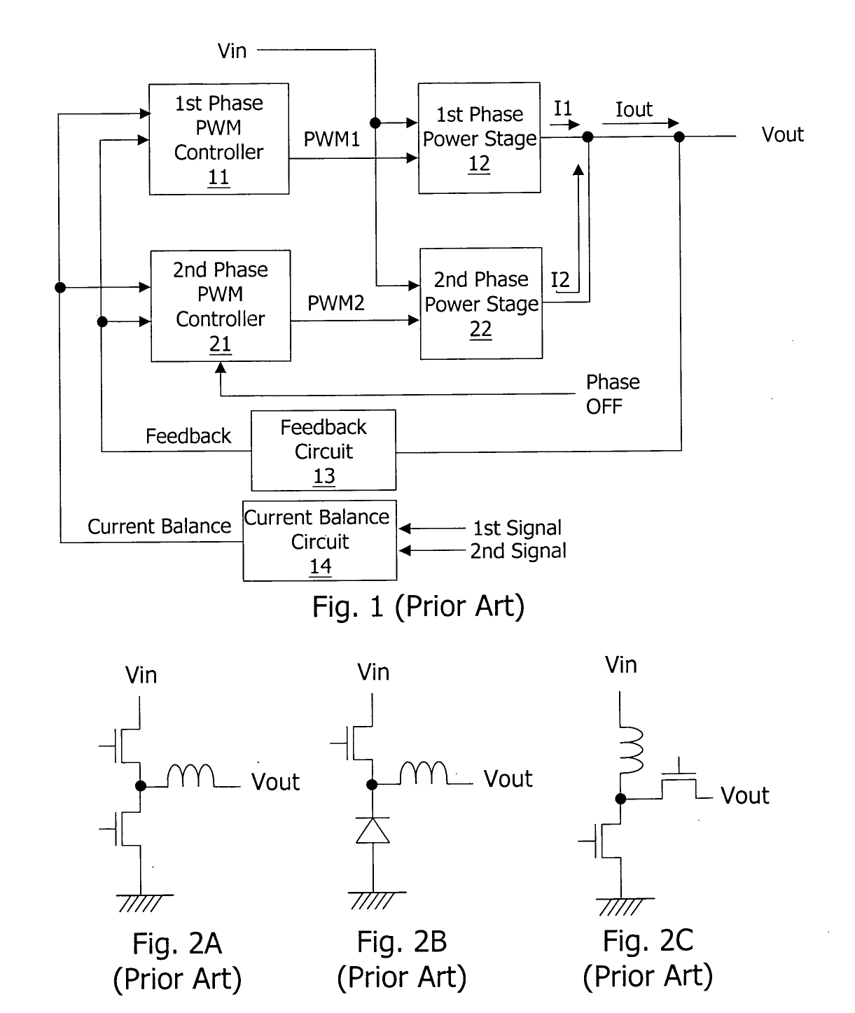

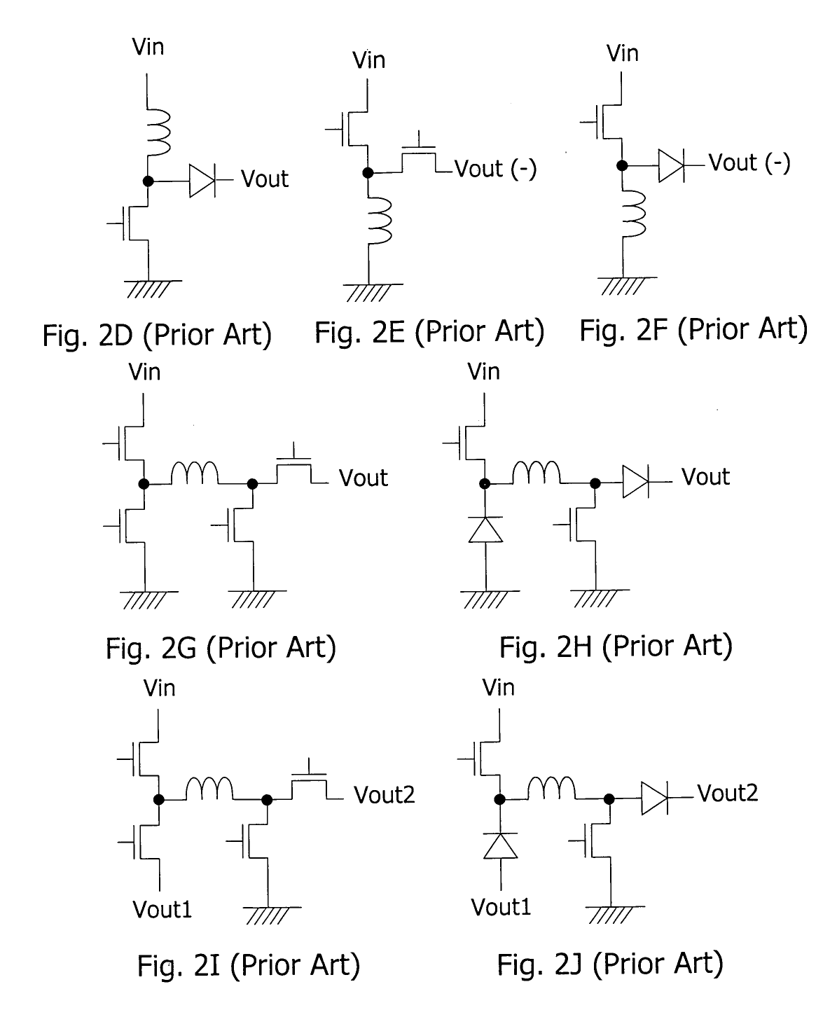

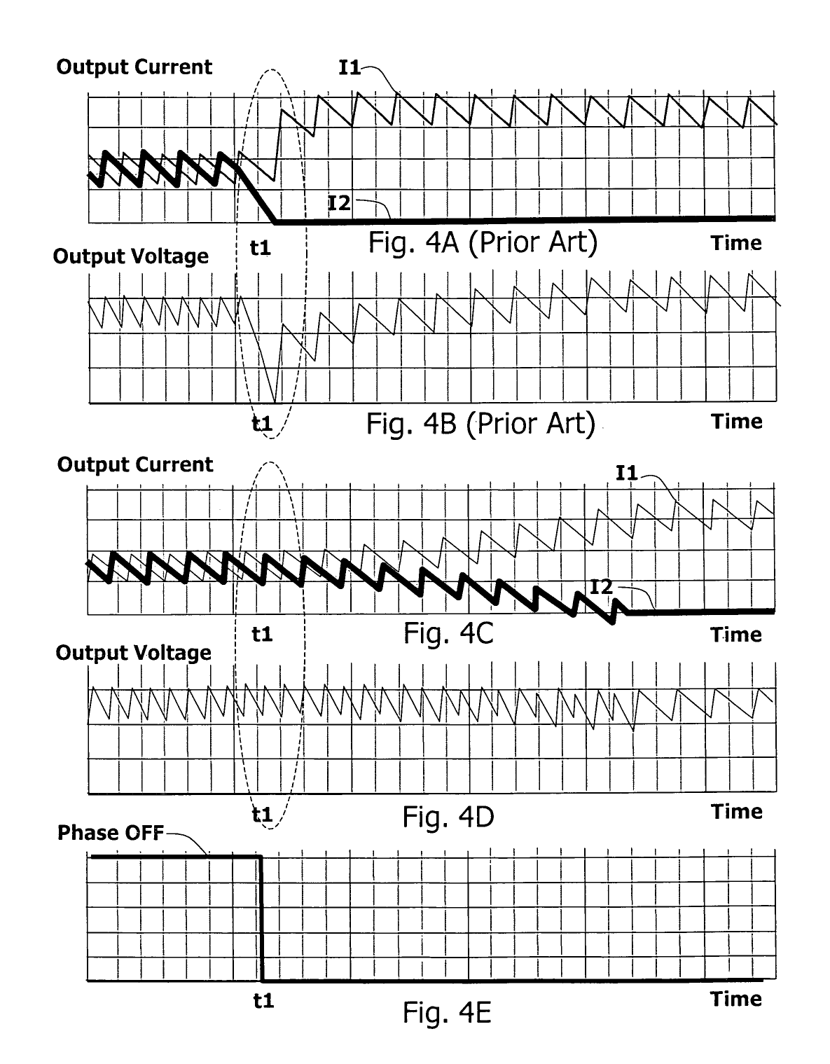

FIGS. 4A-4E illustrate the difference between the present invention and the prior art, in which FIGS. 4A-4B show the waveforms of the output currents and output voltage of a prior art two phase switching regulator, FIGS. 4C-4D show the waveforms of the output currents and output voltage of a two phase switching regulator according to an embodiment of the present invention, and FIG. 4E shows an example of the waveform of the phase off signal. Referring to FIGS. 4A, 4B and the circuit of FIG. 1, and for convenience, assuming that the first phase power stage 12 and the second phase power stage 22 are the synchronous buck converter as shown in FIG. 2A, at time point t1, the phase off signal is triggered to turn off the second phase power stage 22. Referring to FIG. 4A, at this very moment the second phase PWM signal PWM2 is immediately shut down, and it stops supplying the output current I2. Although the first phase power stage 12 increases its duty in response, it takes time for the loop to respond, so the output current I1 of the first phase power stage 12 can not immediately reach the desired output current, and an undershoot of the output voltage Vout occurs as shown in FIG. 4B.

Referring to FIGS. 4C, 4D and the embodiment of FIG. 3, and also and for convenience, assuming that the first phase power stage 12 and the second phase power stage 22 are the synchronous buck converter as shown in FIG. 2A, at time point t1, the phase off signal is triggered to turn off the second phase power stage 22. As shown in FIG. 3, the soft shutdown control circuit 15 receives the phase off signal and generates a soft shutdown signal accordingly, which is inputted to the second phase PWM controller 21 such that, instead of immediately shutting down the second phase power stage 22, the present invention gradually turns off the second phase PWM signal PWM2 generated by the second phase PWM controller 21 (i.e., gradually decreases the duty of the second phase PWM signal PWM2 to zero). Referring to FIG. 4C, at time point t1, the output current I2 of the second phase power stage 22 gradually decreases according to the soft shutdown signal, and the output current I1 of the first phase power stage 12 gradually increases to reach the desired output current; in this way, as shown in FIG. 4D, there is no undershoot in the output voltage Vout.

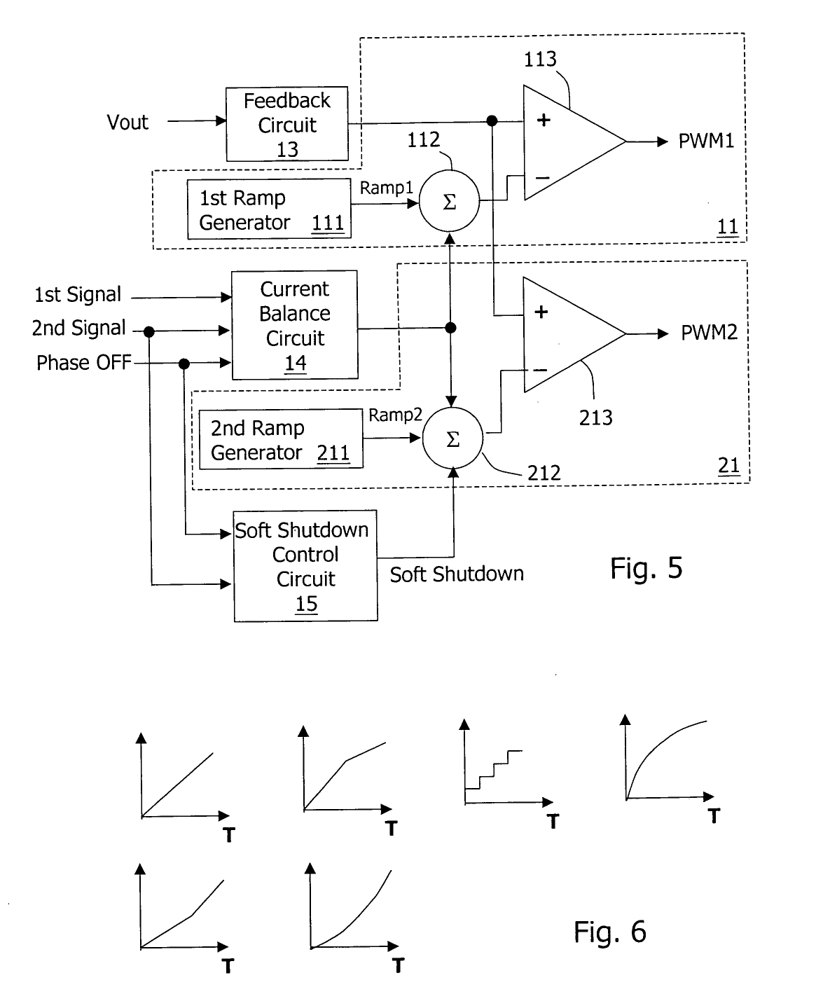

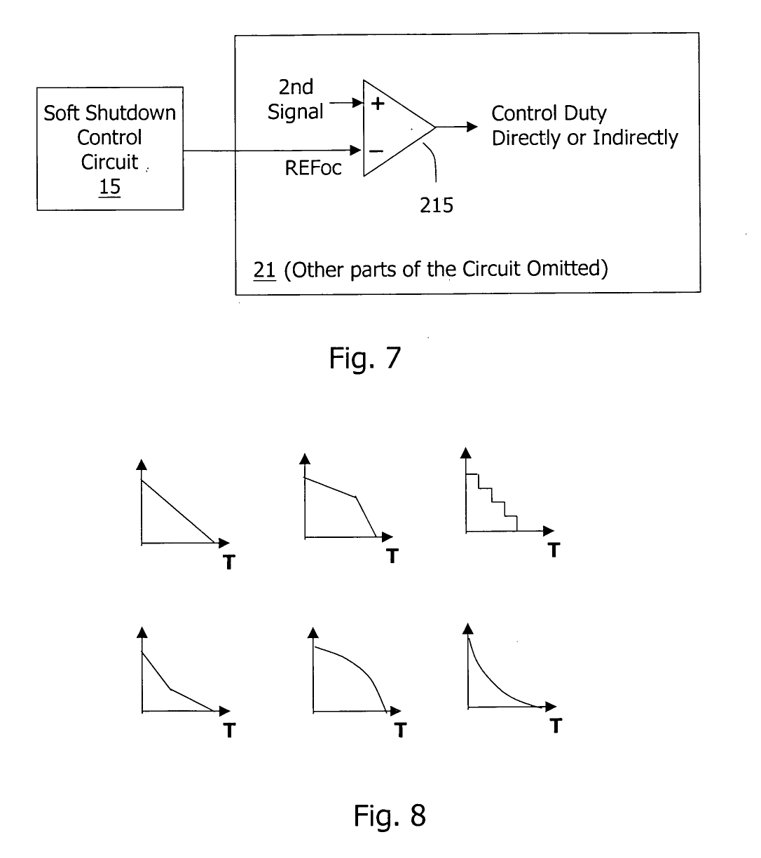

FIG. 5 shows an embodiment illustrating how a soft shutdown signal gradually decreases the duty of the second phase PWM signal PWM2. As shown in FIG. 5, the first phase PWM controller 11 includes a first ramp generator 111 for generating a first ramp signal Ramp1 which is inputted to a summing circuit 112. The summing circuit 112 adds the first ramp signal Ramp1 and a current balance signal generated by a current balance circuit 14, to generate a first sum which is inputted to a first comparator 113. The first comparator 113 compares the first sum with a feedback signal generated by a feedback circuit 13, to generate a first phase PWM signal PWM1. The second phase PWM controller 21 includes a second ramp generator 212 for generating a second ramp signal Ramp2 which is inputted to a summing circuit 212. The summing circuit 212 adds the second ramp signal Ramp2, the current balance signal generated by the current balance circuit 24, and the soft shutdown signal generated by the soft shutdown control circuit 15, to generate a second sum which is inputted to a second comparator 213. The second comparator 213 compares the second sum with the feedback signal generated by the feedback circuit 13, to generate a second phase PWM signal PWM2. The soft shutdown signal for example can be a ramp signal, or any other increasing signal which increases along with time after it is triggered by the phase off signal, as shown by the several examples of FIG. 6. Because the soft shutdown signal is an increasing signal, the second sum gradually increases, and the duty of the second phase PWM signal PWM2 gradually decreases, so that the second phase power stage 22 is softly shut down. When the output current I2 of the second phase power stage 22 is close to or becomes zero, the second phase power stage 22 is completely turned off and the second ramp generator 212 stops generating the second ramp signal Ramp2, to reduce power consumption.

The increasing signals shown in FIG. 6 can be voltage or current signals. If the signal is a voltage signal, it can be generated by continuously or intermittently charging a capacitor by a constant or variable current source. If the signal is a current signal, it can be generated by a variable current source.

FIG. 5 shows another way for the soft shutdown signal to gradually decrease the duty of the second phase PWM signal PWM2. In general, the PWM controllers 11 and 21 are usually under over current protection (OVP), that is, a signal (the first signal or the second signal) relating to the output current I1 or I2 is compared with a predetermined current limit reference signal, and the power transistor in the power stage is under control such that the output current I1 or I2 does not exceed the predetermined current limit. Thus, assuming that the second phase PWM controller 21 is provided with an OCP circuit 215 (the rest of the circuitry in the second phase PWM controller 21 is omitted in the drawing for simplicity), as shown in the figure, it can thus arranged that the second phase PWM controller 21 receives the soft shutdown signal generated by the soft shutdown control circuit 15 as the reference signal REFoc of the OCP circuit 215, and the reference signal REFoc is a decreasing signal which decreases along with time after it is triggered by the phase off signal, as shown by the several examples in FIG. 8. In this way, the duty of the second phase PWM signal PWM2 is gradually decreased, to gradually decrease the output current I2 of the second phase power stage 22 to zero.

The decreasing signals shown in FIG. 6 can be voltage or current signals. If the signal is a voltage signal, it can be generated by continuously or intermittently discharging a capacitor by a constant or variable current source. If the signal is a current signal, it can be generated by a constant current source and a variable current source, wherein the current generated by the variable current source is subtracted from the current generated by the constant current source.

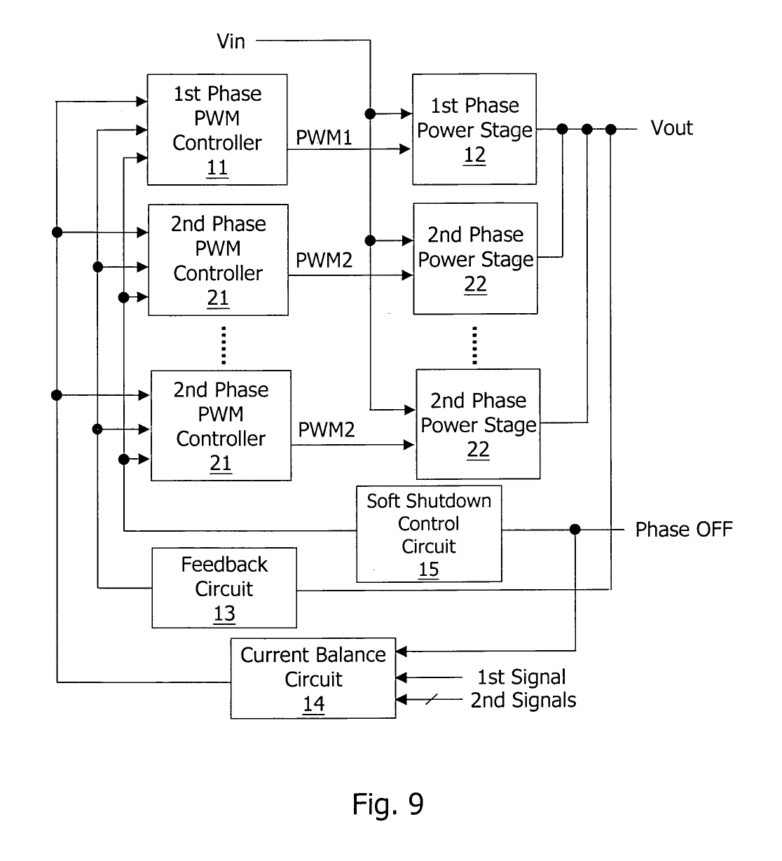

FIG. 9 shows an embodiment of another basic structure of the present invention. The multi-phase switching regulator in this embodiment includes multiple second phase PWM controllers 21 which generate corresponding multiple second phase PWM signals PWM2 in response to the feedback signal, and the soft shutdown signal directly or indirectly decreases the duty of the second phase PWM signal PWM2 of one or more second phase to be turned off, so as to gradually decrease the corresponding output current I2 of the second phase to be turned off to zero.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch or the like. For another example, the meanings of high and low levels of a digital signal, such as the phase off signal, are interchangeable. For another example, the positive and negative input terminals of the comparators 113 and 213 are interchangeable, with corresponding amendment of the circuits processing these signals. For another example, the embodiment of FIG. 5 can be modified in a way that, the soft shutdown signal is added with the output from the feedback circuit 13 instead of the second ramp signal Ramp2 (in this case the soft shutdown signal can be a decreasing signal, or the output from the feedback circuit 13 is added with a negative soft shutdown signal). In view of the foregoing, the spirit of the present invention should cover all such and other modifications and variations, which should be interpreted to fall within the scope of the following claims and their equivalents.

What is claimed is:

1. A multi-phase switching regulator, comprising:
a first phase power stage having at least one first switching power transistor which switches according to a first phase pulse width modulation (PWM) signal to control a first phase output current generated by the first phase power stage;
at least one second phase power stage each having at least one second switching power transistor which switches according to a corresponding second phase pulse width modulation (PWM) signal to control a corresponding second phase output current generated by the second phase power stage, the first phase power stage and the at least one second phase power stage converting a common input voltage to a common output voltage;
a feedback circuit generating a feedback signal according to the output voltage;
a current balance circuit generating a current balance signal according to a first signal relating to the first phase output current, at least one second signal relating to the corresponding second phase output current, and a phase off signal, to distribute current loading among active power stages, wherein the phase off signal determines to turn off one or more of the at least one second phase power stage;
a first phase PWM controller generating the first phase PWM signal according to the feedback signal and adjusting the first phase PWM signal according to the current balance signal;
at least one second phase PWM controller each generating the corresponding second phase PWM signal according to the feedback signal and adjusting the corresponding second phase PWM signal according to the current balance signal; and
a soft shutdown control circuit generating a soft shutdown control signal according to the phase off signal to gradually decrease the second phase output current of the one or more second phase power stages to be turned off to zero.

2. The multi-phase switching regulator of claim 1, wherein each second phase PWM controller includes: a ramp generator generating a ramp signal; and a comparator generating the second phase PWM signal according to the ramp signal, the current balance signal, the soft shutdown control signal and the feedback signal, wherein the soft shutdown control signal is an increasing or decreasing signal which increases or decreases along with time, to gradually decrease a duty of the second phase PWM signal of the one or more second phase power stages to be turned off to zero.

3. The multi-phase switching regulator of claim 2, wherein each second phase PWM controller further includes a summing circuit which adds selected ones of the ramp signal, the current balance signal, the soft shutdown control signal and the feedback signal together and inputs the sum to the comparator to be compared with the rest of the ramp signal, the current balance signal, the soft shutdown control signal and the feedback signal.

4. The multi-phase switching regulator of claim 1, wherein each second phase PWM controller includes a current limit circuit which compares the corresponding second signal with a current limit reference signal to control a duty of the second power transistor in the corresponding second phase power stage, such that the corresponding second phase output current does not exceed a predetermined current limit, wherein the current limit circuit receives the soft shutdown control signal as its current limit reference signal, and the soft shutdown control signal is a decreasing signal which gradually decreases the limit of the corresponding second phase output current to zero such that the corresponding second phase output current decreases to zero.

5. A driver circuit for controlling a multi-phase switching regulator, the multi-phase switching regulator including a first phase power stage having at least one switching power transistor which switches according to a first phase PWM signal to generate a first phase output current and at least one second phase power stage having at least one switching power transistor which switches according to at least one corresponding second phase PWM signal to generate at least one second phase output current, the first phase power stage and the at least one second phase power stage converting a common input voltage to a common output voltage, and the multi-phase switching regulator generating a feedback signal, the driver circuit comprising:
a current balance circuit generating a current balance signal according to the first phase output current, the at least one second phase output current, and a phase off signal, to distribute current loading among active power stages, wherein the phase off signal determines to turn off one or more of the at least one second phase power stage;
a first phase PWM controller generating the first phase PWM signal according to the feedback signal and adjusting the first phase PWM signal according to the current balance signal;
at least one second phase PWM controller each generating the corresponding second phase PWM signal according to the feedback signal and adjusting the corresponding second phase PWM signal according to the current balance signal; and
a soft shutdown control circuit generating a soft shutdown control signal according to the phase off signal to gradually decrease the second phase output current of the one or more second phase power stages to be turned off to zero.

6. The driver circuit of claim 5, wherein each second phase PWM controller includes: a ramp generator generating a ramp signal; and a comparator generating the second phase PWM signal according to the ramp signal, the current balance signal, the soft shutdown control signal and the feedback signal, wherein the soft shutdown control signal is an increasing or decreasing signal which increases or decreases along with time, to gradually decrease a duty of the second phase PWM signal of the one or more second phase power stages to be turned off to zero.

7. The driver circuit of claim 5, wherein each second phase PWM controller further includes a summing circuit which adds selected ones of the ramp signal, the current balance signal, the soft shutdown control signal and the feedback signal together and inputs the sum to the comparator to be compared with the rest of the ramp signal, the current balance signal, the soft shutdown control signal and the feedback signal.

8. The driver circuit of claim 5, wherein each second phase PWM controller includes a current limit circuit which compares the corresponding second signal with a current limit reference signal to control a duty of the switching power transistor in the corresponding second phase power stage, such that the corresponding second phase output current does not exceed a predetermined current limit, wherein the current limit circuit receives the soft shutdown control signal as its current limit reference signal, and the soft shutdown control signal is a decreasing signal which gradually decreases the limit of the corresponding second phase output current to zero such that the corresponding second phase output current decreases to zero.

9. A control method for controlling a multi-phase switching regulator, the multi-phase switching regulator including a first phase power stage having at least one switching power transistor which switches according to a first phase PWM signal to generate a first phase output current and at least one second phase power stage having at least one switching power transistor which switches according to at least one corresponding second phase PWM signal to generate at least one second phase output current, the first phase power stage and the at least one second phase power stage converting a common input voltage to a common output voltage, and the multi-phase switching regulator generating a feedback signal, the control method comprising:
generating a current balance signal according to the first phase output current, the at least one second phase output current, and a phase off signal, to distribute current loading among active power stages, wherein the phase off signal determines to turn off one or more of the at least one second phase power stage;
generating the first phase PWM signal according to the feedback signal and adjusting the first phase PWM signal according to the current balance signal;
generating the at least one second phase PWM signal according to the feedback signal and adjusting the at least one second phase PWM signal according to the current balance signal; and
generating a soft shutdown control signal according to the phase off signal to gradually decrease the second phase output current of the one or more second phase power stages to be turned off to zero.

10. The control method of claim 9, wherein each second phase PWM signal is generated according to a ramp signal, the current balance signal, the soft shutdown control signal and the feedback signal, wherein the soft shutdown control signal is an increasing or decreasing signal which increases or decreases along with time, to gradually decrease a duty of the second phase PWM signal of the one or more second phase power stages to be turned off to zero.

11. The control method of claim 9, wherein the soft shutdown control signal is a decreasing signal which gradually decreases the limit of the second phase output current of the one or more second phase power stages to be turned off to zero such that the corresponding second phase output current decreases to zero.
